(19) United States
(12) Patent Application Publication
(10) Pub. No.: US 2017/0236166 A1
(43) Pub. Date: Aug. 17, 2017

(54) ONLINE METHOD OF CREATING ADVERTISING PAGES ON A WEBSITE AND MANAGING THE CONTENT OF SAID PAGES

(71) Applicant: Roman Pavlovich Cheskidov, Ekaterinburg (RU)

(72) Inventor: Roman Pavlovich Cheskidov, Ekaterinburg (RU)

(21) Appl. No.: 15/504,326

(22) PCT Filed: Jan. 29, 2015
(86) PCT No.: PCT/RU2015/000050

§ 371 Date: Feb. 16, 2017

(51) Int. Cl. G06Q 30/02

(52) U.S. Cl. CPC G06Q 30/0276; G06Q 30/0277

(57) ABSTRACT

The invention is directed to drawing the attention of visitors to advertised items and to encouraging visitors to carry out actions desirable to advertisers. The present method delimits a function for creating and populating a website with content (publisher function) and a function for drawing the attention of visitors to commercial products and for interacting with visitors (advertiser function). The role of the publisher in terms of the commercialization of the content they create consists merely in placing WPSM within a web page without having to change the site template. As a result, it becomes technically possible for advertisers to legally obtain content that is already indexed and is attractive to users. By virtue of the participation of the publisher and the use of instructions created by the publisher, content is included in a block of feedback (BOF) of an advertiser upon fulfillment of CAMS rules, thus increasing website visitor trust in advertising materials and making advertising more effective. Content can also be included in a web page by means of the positioning of the content in relation to a BOF.

This invention pertains to the online advertising by means of web pages; it is designed to attract visitors' attention to advertised products and for motivating these visitors to take actions desired by advertisers.

Web Page, or a page, refers to a general term used to describe here a document, a file, a data resource, an application within the World Wide Web (the Internet) that is accessible by other computer devices with hardware and software system including, but not limited to, a web browser, and has in some realizations a unique Internet address, i.e., an URL (uniform resource locator).

Content is a part of, or sometimes the whole web page that forms the principle and unique content different from any other web pages, and that is linked with the unique page address in the Internet—URL (uniform resource locator). The content is designed for visitors and the search engines to extract (retrieve) main information from the web page. In many cases it is used in order to form meta-descriptions of that page in such tags as <meta name=title>, <meta name=description>, <meta name=keyword>. The content, as a rule, possesses such qualities as uniqueness and relative stability. Examples of the content are a text, a game, a forum, a video program, an audio file, online calculator, etc.

Content Management System, or CMS, is a hardware and software system including, but not limited to, an individual computer (-s), server or servers, programs (program code), applications, data base (-es) that support the process of content creation, edition and management as well as output of web pages according to the general rules of content output set forth by administrators for visitors.

Content and Advertising Management System, or CAMS, is a hardware and software system including, but not limited to, an individual computer (-s), server or servers, programs (program code), applications, data base (-es) that supports the process of creation, edition and management of any content, BOF's, instructions, rules, as well as output of data including, but not limited to, BOF's, content, web pages according to the rules of content and BOF output set forth by administrators.

Block of feedback, or BOF (Block of feed—feed-items, feedback, feed-services, feed information, etc.) is a part (-s), an element (-s), a block (-s) or a section (-s) of web pages, applications, web-links, menus, logos, design or their combinations, which attract the attention of the visitors to the advertised object and motivate them to perform desired actions of the visitors. A BOF may not, and often is not linked with any URL, i.e., the web page address in the Internet. That means, it can be identical for different web pages. The BOF is not linked directly with any content, and it may not be unique within the web pages or the Internet. A BOF can contain, but not limited to, advertiser's name, phone number, image of its trade mark or/and products, technical data of the products, feedback blocks, answers to questions, instructions, manuals, services, a program executable code, web-links, menus with links to any other pages that may be of interest to the advertiser, etc. A BOF may be created by one advertiser, or it may consist of several BOF's of one o more advertisers or/and third party providers.

End user, or user, is an operator controlled hardware and software system that registers in the CAMS and has been assigned an account.

Publisher is a type of the end user that has the rights to create and modify any URL linked web pages or/and applications in the Internet or their part (-s), element (-s), block (-s) and section (-s), inputs instructions for the content, or/and agrees with the CAMS terms by default.

Advertiser is a type of the end user that has saved one or more BOF's or links thereto, inputs instructions for the BOF, or/and agrees with the CAMS terms by default. An advertiser, a publisher or/and a CAMS may be the same entity.

Visitor, or a web page visitor, or application visitor is an operator controlled hardware and software system including, but not limited to, browsers, with all rights that are normally granted to an unlimited number of computers, or computer devices connected or have access to the Internet. In some realizations, visitors call URL's of web pages and download files from the CMS's as responses to their certain queries; they also perform any other operations including, but not limited to, desired actions of the visitors.

Script is a program that may be written in one of the programming languages, for example, JavaScript, flash, java, etc.

Web Page Management Script, or WPMS, is a script or a link to a script for data transfer among the CAMS, the end users or/and the visitors, for web page or application transformation and output, including, but not limited to, sending and receiving web page request parameters, retrieving of the content, or extracting its parts, or any other parts of the web page; receiving and composing of parts, elements, blocks or sections of the web page, web links, menus, pictures, logos, design elements or their combinations as well as any similar elements received from the CAMS, including, but not limited to, BOF, publisher's content, visitor's content, web services, modules, plugins, widgets, etc.

Instructions are a set of algorithmic solutions entered/input by CAMS users that are expressed via permission, prohibition, obligation, exception or any other logic operations with regard to using the web page content or any blocks thereof for publishers or, respectively, BOF and its individual blocks for advertisers, including, but not limited to, joint output of the content and the BOF.

CAMS rules are a set of algorithmic solutions formulated by the CAMS, that are expressed via permission, prohibition, obligation, exception or any other logic operations, based on, but not limited to, instructions of publishers and advertisers for output a part (-s), an element (-s), a block (-s) or a section (-s) of a web page or an application upon visitor's request, with or without the BOF. One of specific options of such rules is an auction, i.e., the rule determining a display option of a web page in case there are several competing instructions from publishers or/and advertisers. Within the auction, the concept of competition is implemented between end users on the monetary or any other basis as well as the general auction rules set forth by CAMS administrators.

Desired actions of the visitors are BOF enabled operations including, but not limited to, data, file input/output, upload and file transfer performed by the hardware and software system of the visitor beyond simply calling URL's of web pages and uploading a file in reply to a certain request. Possible examples of such desired actions of a visitor include, but not limited to, groups of operations, which perform the following functions:
using a link to visit another web page or application;
sharing the URL of this page to a third party;
bookmarking;
subscribing to be placed on a mailing list, news, etc.;
uploading files;
watching video clips;
viewing price lists;
filling out an order form or a feedback form;
making softphone calls;
calling a phone number;
requesting information via online consulting systems;
requesting quotes, information,
placing orders,
making payments, etc.

### DESCRIPTION OF THE BACKGROUND

Online publications are a successful alternative to the printed products. They reduce the costs of production and distribution advertised material. Some known processes of creating advertising publications, that are closely related to the claimed invention, include the following:

U.S. Pat. No. 8,392,246, Pub. No.: US 2009/0063229 A1, Pub. Date: Mar. 5, 2009 Coladonato; Greg (Palo Alto, Calif.), Jaeger; Juliana (Mountain View, Calif.), Taylor; Karen Padham (Los Gatos, Calif.), Gil; Elad (Palo Alto, Calif.). Other reference numbers: WO2009029813A2, WO2009029813A3;

Pub. No.: US 2007/0219940 A1 Pub. Date: Sep. 20, 2007 Raymond J. Mueller, Palm Beach, Gardens, Fla. (US); Andrew S. Van, Luchene, Santa Fe, N. Mex. (US); Dean, Alderucci, Westport, Conn. (US).

U.S. Pat. No. 8,392,246 (US 2009/0063229 A1) is the closest one to the claimed method. The known process is designed for advertising using publications such as web pages, digital files, audio materials and files, video materials and any other types of electronic files, etc. Content of such publications include graphs, text components, graphical or symbolic fonts.

In the prototype, an advertiser rates the publisher's content, and the advertising distribution system rates the relevance of ad content. One of implementations of the known method also includes an advertising management system, within which, based on ratings received, advertisers set displaying rules of the BOF's jointly with the content. The known method understands the content as the whole web page, and joint displaying simply means that some ads will be added to the existing web page. The ultimate web page is complemented by ads of advertisers, which, as explained above, are regarded as operator controlled hardware and software systems. User access rights with relation to the web page content (such rights are called ‘rights’ in the technical sense) are split.

In the prototype, both the web page and its content are regarded in a similar manner from the technical and content aspects. The system uses the result of a technical object that is external with relation to the method, namely, a web page into which some advertising blocks can be inserted; the web page is created by a user that is independent of the advertiser, and the claimed method calls it a publisher. Therefore, the publisher has no role in the prototype, and is expressed in the form of the result, i.e., a web page offered to the advertiser. It should be noted that there are some known systems, too, where publishers are supposed to unconditionally accept displaying of ads, irrespective of anything. As a result, the ultimate web page with advertising materials (further—the BOF) is created as a simple combination of the original web page with one or more BOF's from advertisers. Consequently, the BOF's, or advertising blocks often fail to match the original web page design, look strange, and are perceived by end users as ‘advertising’, i.e., an addition of commercial nature.

Another drawback of the known existing method is the fact that the advertiser's BOF is added to the web page, and starts competing for visitors' attention. Visitors have to choose or/and switch their attention between the web page's main content, publisher's BOF and advertiser's BOF. This makes placement of such advertising less efficient for the advertiser, and the publisher's brand is damaged to some extent. In addition, information overloads web pages and conflict with the intentions of the visitors, who visit a web page to find some content that would reply to their questions, and seldom start by searching for advertisers' details.

The task of the claimed method is to ensure the technical feasibility of using the web page content for advertising purposes only, i.e., those parts of the web page that reflect its main content.

To this end, the claimed method includes a new user—the publisher and its extended capabilities in terms of controlling its own content or delegating these rights to other technical systems in some cases in order to create and display the ultimate web pages at other devices.

A specific feature of the modern online space is that, while some sites (CMS's, applications) publish mostly information materials, other CMS's mostly offer advertising materials. Advertisers have to find some content that does not have to be advertising by nature, but will be attractive for visitors; however, they have no adequate technical capabilities for that, and they are forced to simply add their ads to the existing web pages. In addition, there appears differentiation of labor between those who create and place materials containing information that is useful for visitors (‘publishers’) and those who are interested in attracting visitors (‘advertisers’). Each of these two user groups has their own interests and different tasks, which can be implemented via technical functions.

The prototype has implemented the advertising management functions by means of content rating; however, the publisher has no technical capability for stating the terms of content usage. The publisher is not present in the prototype as a technical object implementing some active functions. The claimed method creates the opportunity for interaction of publishers and advertisers that represent different CMS's. So that, it is possible for the visitor's display to show a web page consisting of the publisher's content and the advertiser's BOF. The focus is on simplification, reduction of the requirements to technical systems, accelerated obtaining of results and the concept of exchanging of newly created values.

### BRIEF SUMMARY OF THE INVENTION

The claimed method envisages the involvement of the Content and Advertising Management System—CAMS, and of such users as ‘the advertiser’, similarly to the prototype, and the new user—‘the publisher’. The advertiser sends to the CAMS instructions for the BOF, the publisher sends instructions for the content, and the CAMS uses them as a basis for preparing the rules for joint output of the BOF and the content for the visitors. The objective of the method is to enable the visitor to output web pages as either a web page without any blocks of feedback (BOF's) of advertisers, or as a combination of the publisher's content and the advertiser's BOF, depending on the rules to be set forth by the CAMS. This method allows for implementing, in particular, exchange, auction and other models for presenting the publishers' content to advertisers.

### DESCRIPTION OF THE INVENTION

In contrast to the prototype, the method under presentation offers a qualitative modification to the use of the web page content for advertising purposes.

The method is implemented via interaction of the Content and Advertising Management System (further—CAMS), the advertiser, the publisher and the visitor (FIG. 1).

In all the cases of the method (FIG. 2), publishers place their content in their individual content management systems (further—CMS's) located on a hosting of their choice. As a result, web pages are created with individual URL's and with the option of displaying certain designs. These web pages become available to an unlimited range of visitors and, in particular, to search engines for indexing purposes. Then the publishers register in the CAMS, are assigned accounts, log into the CAMS, and become capable of interacting with advertisers. To this end, the publishers receive a web page management script (WPMS), place this script in the publishers' web pages and input instructions into the CAMS regarding the use of the content. In contrast to the prototype, instructions may be in arbitrary form. Also, in contrast to the prototype, the publishers do not need to change the web page markup and allocate any special places for the advertisers' BOF's. It is automated by means of the WPMS.

Advertisers register in the CAMS, are assigned accounts, and log into the CAMS, and become capable of interacting with publishers. Advertisers create blocks of feedback (further—BOF's) for visitors in the form of brand banners, templates with banners or any other blocks for desired actions of the visitors. Advertisers specify the place for the content, or/and arrangement of content blocks and BOF's, or/and their integration rules and save the BOF's in the CAMS or save the BOF's in separate files, while links to the BOF's are saved in the CAMS. To facilitate the creation of BOF's, advertisers may use, but not obliged to, a special editor in their personal CAMS accounts, which special functions include, but not limited to, downloading, coping and pasting, editing, formatting and saving of BOF's. In contrast to the prototype, advertisers do not need to create banners according to certain dimensions or properties and make them compatible with the design of the publishers' web pages. Advertisers can use for BOF creation any web page design by specifying the place for inserting the content or specify the method of content and BOF combination. Web page formation is automated by means of a web page management script—WPMS. Advertisers input instructions into the CAMS with regard to the use of BOF's. In contrast to the prototype, instructions may be in arbitrary form.

According to the first case of the method implementation (FIG. 3), visitors call web pages with WPMS via URL's. The publishers send the web pages with WPMS and URL's to the visitors. The visitors receive the web pages, or parts of them, and start WPMS. The WPMS script sends web page request parameters to the CAMS. These data may include, but not limited to, geographical location of the visitors, request date and time, search phrase and any other data. The CAMS receives the request parameters and checks them for compliance with the rules set forth by the CAMS. If the parameters do not comply with the CAMS rules, the visitors are informed thereof, display web pages without BOF's or/and process them in other ways. If the parameters comply with the CAMS rules, the CAMS sends the BOF's or links to the BOF's, and the visitors receive the BOF's directly from the CAMS or using the links respectively. The WPMS extracts the content from the publishers' web pages and create web pages as BOF's and content. After that, the newly created web pages are displayed in the visitors' screens or/and processed in other ways.

According to the second case of the method implementation (FIG. 4), visitors call web pages with WPMS via URL's. The publishers send to the visitors the web pages with WPMS and URL's. The visitors receive the web pages, or parts of them, and start WPMS. The WPMS sends web page request parameters to the publishers CMS's or directly to the CAMS. These data may include, but not limited to, geographical location of the visitor, request date and time, search phrase and any other data. The CAMS receives the request parameters and checks them for compliance with the rules set forth by the CAMS. If the parameters do not comply with the CAMS rules, the visitors are informed thereof via the publishers or directly from the CAMS, display web pages without BOF's or/and process them in other ways. If the parameters comply with the CAMS rules, the CAMS sends the BOF's or links to the BOF's, and the publishers receive the BOF's directly from CAMS or using the links respectively. The publishers create the web pages as BOF's and content. After that, the publishers send, and the visitors receive the newly created web pages, and the pages are displayed in the visitors' screens or/and processed in other ways.

According to the third case of the method implementation (FIG. 5), the CAMS calls web pages with WPMS via URL's, receives them from the publishers, extracts and saves some content and, possibly, other data. Visitors call the web pages with WPMS via URL's. The publishers or CAMS send web pages with WPMS and URL's to the visitors. The visitors receive the web pages, or their parts, and start WPMS. The WPMS script sends web page request parameters to the CAMS. These data may include, but not limited to, geographical location of the visitor, request date and time, search phrase and any other data. The CAMS receives the request parameters and checks them for compliance with the rules set forth by the CAMS. If the parameters do not comply with the CAMS rules, the visitors are informed thereof, display web pages without BOF's or/and process them in other ways. If the parameters comply with the CAMS rules, the CAMS creates web pages as BOF's and content. After that, the CAMS sends, and the visitors receive the newly created web pages, and the pages are displayed in the visitors' screens or/and processed in other ways.

Novelty of the claimed method lies in the fact that the publishers are enabled to manage their web pages. In the prototype, web pages are regarded with preset places for inserting advertisers' banners. It is assumed that the preset places already include codes for uploading banners, i.e., an analogy of the web page management script (WPMS). Banners are added to the publisher web pages; they often conflict with the content and theme of the publisher original web pages and, in any case, stand out as ads. In the claimed method, the CAMS offers to publishers a web page management script—WPMS, or a link to the WPMS. Visitors, or publishers, or the CAMS use the WPMS to extract the content from the web pages they have received, create web pages as a combination of the content and BOF, and visitors output them to display or/and to process in other ways. This system allows lowering the technical barrier that the publishers have to overcome in order to provide their content for advertising purposes, and the whole procedure is accelerated and simplified, as it boils down to adding one WPMS to a web page only once, and practically in any place of the web pages. Further, the WPMS ensures retrieving of the content, output of the publisher web page content with or without the BOF, depending on the settings, and maintains communication with the CAMS. The web pages and their design are almost completely transformed, while the URL's addresses are maintained, and the rules are observed with regard to web page indexing by search engines. When outputting such web pages, the visitors receive the content either as part of the original design, or of the advertisers' BOF's, which improves the perception of both the content and the advertisers' messages. When the content is output with the advertisers' BOF's, the visitors in some realizations will perceive this web page as normal advertisers' web pages with content, not as a sales promotion.

Another novelty of the claimed method is creation of an advertising carrier (advertiser's BOF) and its integration with the publisher's content. In the prototype, the feature similar to the advertiser's BOF is a text ad or a banner (further—a banner) that consists of a code written specially for advertising purposes to be included into the publisher's web page. In the claimed method, advertisers create BOF's for visitors, specify the place for the content or an integration method of the BOF's and the content, and the CAMS saves BOF's or URL links to the BOF's, and sends the BOF's or URL links to the BOF's to visitors. This system changes significantly the technique of displaying web pages with advertising. In the claimed method, the advertisers' BOF's is a ‘container’ for the publisher's content, and not vice versa. Thereby, publishers avoid technical issues related to provision of pre-indexed web pages for advertising use, as they do not have to modify the page markup and operate numerous scripts any more. It simplifies the creation of the advertisers' BOF. In some realizations, a source code of the advertiser's web page with a specified place for content can act as the advertiser's BOF. In that case, all that the advertisers have to do is to select a place for inserting the publisher's content and to mark somehow this place, for instance, with a predefined set of symbols. After that, the claimed method outputs the web pages as the code of the advertisers' web pages (or any other advertisers' BOF) together with the publishers' content that has been inserted in the specified places or combined with the BOF's. The advertiser's BOF may include a simple BOF with typical web page design of the advertiser's web site including contact details or a composite design consisting of several BOF's. A template consisting of several banners can be an example of the composite design including multiple BOF's.

Novelty of the method according to the first case of implementation is the fact that the main functions, related to creation of web pages for outputting, are transferred to the visitors. In the prototype, web pages are a fact of life; their creation is outside the scope of the method, and BOF are uploaded by visitors. In the first case of the claimed method, visitors receive web pages or their parts with WPMS, start the WPMS and send request parameters to the CAMS, and if the parameters do not comply with the CAMS rules, the visitors are informed thereof, output web pages without BOF's or/and process them in other ways, and if the parameters comply with the CAMS rules, visitors of web pages with URL's receive BOF's from the CAMS or via the URL links sent from the CAMS. Then the visitors use the WPMS to extract the content from the received web pages, create the web pages as a combination of the content and BOF's or/and their blocks and output them for display or other use. In other words, the main technical operations related to creation of the ultimate web pages take place at the visitors' side: retrieving of the content, combining it with BOF's.

Novelty of the method according to the second case of implementation is the fact that publishers create web pages, containing BOF' s. In the prototype, web pages are a fact of life; their creation is outside the scope of the method, and BOF's are uploaded by visitors. According to the second case of the claimed method, visitors receive web pages or their parts with WPMS, start the WPMS and send request parameters to the CAMS, and if the parameters do not comply with the CAMS rules, the visitors are informed thereof, output web pages without BOF's or/and process them in other ways, and if the parameters comply with the CAMS rules, publishers receive BOF's from the CAMS or via the URL links, create the web pages as a combination of the content and BOF's or/and their blocks and output them for display or other use. After that, the publishers' send complete web pages to the visitors, without the need for subsequent uploading of BOF's. In this case, the main technical operations related to creation of the ultimate web pages take place at the publishers' side: retrieving of the content, combining it with BOF's.

Novelty of the method according to the third case of implementation is the fact that CAMS creates web pages containing BOF' s. In the prototype, web pages are a fact of life; their creation is outside the scope of the method, and BOF's are uploaded by the visitors. According to the third case of the claimed method, visitors receive web pages or their parts with WPMS, start WPMS and send request parameters to the CAMS; the CAMS calls web pages with URL via the Internet, receives the publishers' web pages, retrieves and saves the content from the received publishers' web pages; receives request parameters to check the CAMS rules for outputting the content and BOF's, checks the parameters for compliance with the CAMS rules; if the parameters do not comply with the CAMS rules, the visitors are informed thereof, output web pages without BOF's or/and process them in other ways, and if the parameters comply with the CAMS rules, the CAMS creates the web pages as a combination of the content and BOF's or/and their blocks. After that, CAMS sends complete web pages to the visitors, without the need for subsequent uploading of BOF's. In other words, the main technical operations related to creation of the ultimate web pages take place at the CAMS side: retrieving of the content, combining it with BOF's.

In all the cases of the claimed method, the CMS of the publishers and of the advertisers do not need upgrading or any modifications, except the currently well-established operation of inserting into the publisher's web page of a code for communication with the CAMS and uploading of an external script or inserting a link to it. In other words, if the publishers are ready to provide their web pages with high traffic to the advertisers, it does not mean that the design would have to be changed in the publisher's CMS. In some realizations, it becomes easier to extract some content, combine it with BOF and output a new web page at the page visitor's side.

The claimed method also features a new advertising management system, in which the publisher is involved into the process, and the rules created in the CAMS are not only based on the advertiser's instructions, but the publisher's instructions as well. In the known method, the prototype of the CAMS collects ratings of the advertisers' content. Accordingly, advertisers can set instructions for displaying of their ads depending on these ratings. In contrast to the prototype, where publishers had no role, were assumed and expressed in the form of the result, i.e. a web page offered to the advertiser, in the claimed method, both publishers and advertisers create and save instructions for using the content with URL's and BOF's in the CAMS, and the CAMS saves instructions for using the content with the URL's, saves instructions for the BOF's, and creates the CAMS rules for displaying the content and BOF's based on the instructions of publishers and advertisers. Therefore, both advertisers and publishers have equal rights to save direct instructions (not only depending on the ratings) with regard to the advertising with content, and the content with advertising, respectively. This creates a basis for complex auction models for joint displaying of the content and advertising. The range of parties involved in such auctions may include both advertisers, that set their terms and conditions, and publishers with their terms and conditions.

As a result, in some realizations of the claimed method, the visitor's screens will display web pages with one piece of content under the same URL link, but with different blocks of feedback (overall designs, advertising modules, banners, plugins, widgets, etc.) depending on compliance or noncompliance by visitor URL request parameters with the CAMS rules. In other words, when requesting a web page with the same URL, different visitors will display web pages with different BOF's (overall designs, advertising modules, banners, plugins, widgets, etc.) Note that, in contrast to the existing advertising techniques, the only initial difference between these web pages will be the presence of the web page management script (WPMS).

Another advantage of the new method with relation to the prototype is the fact that it separates the function, which creates and fills the web page or an application with content (the publisher function) and the function, which attracts the visitors' attention to commercial products and interacts with the visitors (the advertiser function). In this case, the publisher's task with regard to commercialization of the content, created by the publisher, will boil down to placing the WPMS within the web page, without the need to change the web site or an application template. This is the new technical result of the claimed method. Hereby, it becomes technically possible for the advertisers to obtain legally the content that has been indexed or installed and is attractive to visitors. Thanks to involvement of the publishers, and by way of using of their instructions, the content (if the parameters comply with the CAMS rules) is included into the BOF's of the advertisers. This increases the visitors' confidence in advertising materials and makes sales promotion more efficient. The content may be combined with the web pages i.e. via its positioning with relation to the BOF or its blocks.

Involvement of publishers in the creation of the web pages, envisaged by the claimed method, makes it possible to use economic mechanisms for creation of web pages from the blocks pertaining to different user types, in this case—to the publisher (content) and the advertiser (BOF); their respective areas of competence correspond to their respective blocks. Therefore, the publisher's content acquires more features of a commodity, its use and disposal take the shape of commodity-money exchange, and the content creation costs start to pay back.

Persons supporting the advertisers have their individual views as to their desired visitors and to the desired methods of interaction with them. Therefore, they have the priority in the area of creating the BOF's and determining the rules and ways of interaction with visitors. Persons supporting the advertisers and the publishers, while performing their individual roles within their respective competences, appear to be interested in technical implementation of cooperation with each other.

The claimed method has one more advantage. Creation of the content is in most cases the result of intellectual activity (RIA) that is copyright protected. Persons supporting the publishers can be interested in technical implementation of observation of the legal rights for such results. These people also can be interested in using the RIA via cooperation with the persons supporting the advertisers as well as in exchange of their RIA's and other persons' RIA's. Considering the fact, that creation and placement of the content (texts, audio and video materials and any other data) in the content management systems (CMS's) or applications is a labor intensive process requiring a certain qualification of the staff, RIA creation and placement costs will be justified in case there are guaranties of subsequent copyright protection with respect to the content of the persons supporting the publishers. The claimed method offers a technical opportunity for that via content identification by means of the URL's, confirmation of the publishers' rights for the URL's and providing the publishers with the possibility of establishing the instructions for using the content that is identified on the basis of the URL, authorization and the rights of end user—the publisher.

### DETAILED DESCRIPTION OF EXAMPLES OF EMBODIMENTS

For the purposes of technical implementation of the claimed method, certain hardware and software systems controlled by operators are used including, but not limited to, servers, desktop computers, laptop computers, tablets, personal digital assistants and mobile devices. In order to visit the web pages, operators managing the visitors can use symbol or/and signal I/O devices, central processor unit (‘CPU’), data storage unit and network unit. Typical symbol or/and signal I/O devices include a keyboard, mice, displays, microphones, speakers, disk drives, CD-ROM drives and memory sticks. Other types of devices can be used as well. Among the multiple data located in the data storage unit, there is the client operating system (‘OS’) and certain client applications. The client OS is a program that controls hardware and software resources of the client system. Applications of OS's use their resources in order to perform tasks instructed by the operators of CAMS, publishers', advertisers' and visitors'.

Note that the method here, as well as in the prototype, means a coordinated sequence of operations leading to the desired result. These operations are of technical nature since they require physical manipulations with physical quantities in the form of electrical or magnetic signals that can be stored, transmitted, combined, compared and subjected to other manipulations. These signals are commonly referred to as bits, symbols, digits, etc. In other words, the terms describing the operations within the claimed method are connected with the respective physical quantities, but they are used as convenient tags applied to such quantities.

A user access level within the data base is assigned in the CAMS control module to each user that can be either a publisher, or an advertiser, or both. This access level enables them to perform functions including, but not limited to, uploading, coping and pasting, editing, formatting, saving and viewing of the respective content or/and BOF's.

### BRIEF DESCRIPTION OF THE DRAWINGS

The invention is illustrated by the following figures:

FIG. 1 shows the implementation system for the claimed method;

FIG. 2 shows the general part of the implementation scheme (algorithm) for the claimed method according to cases 1, 2 and 3;

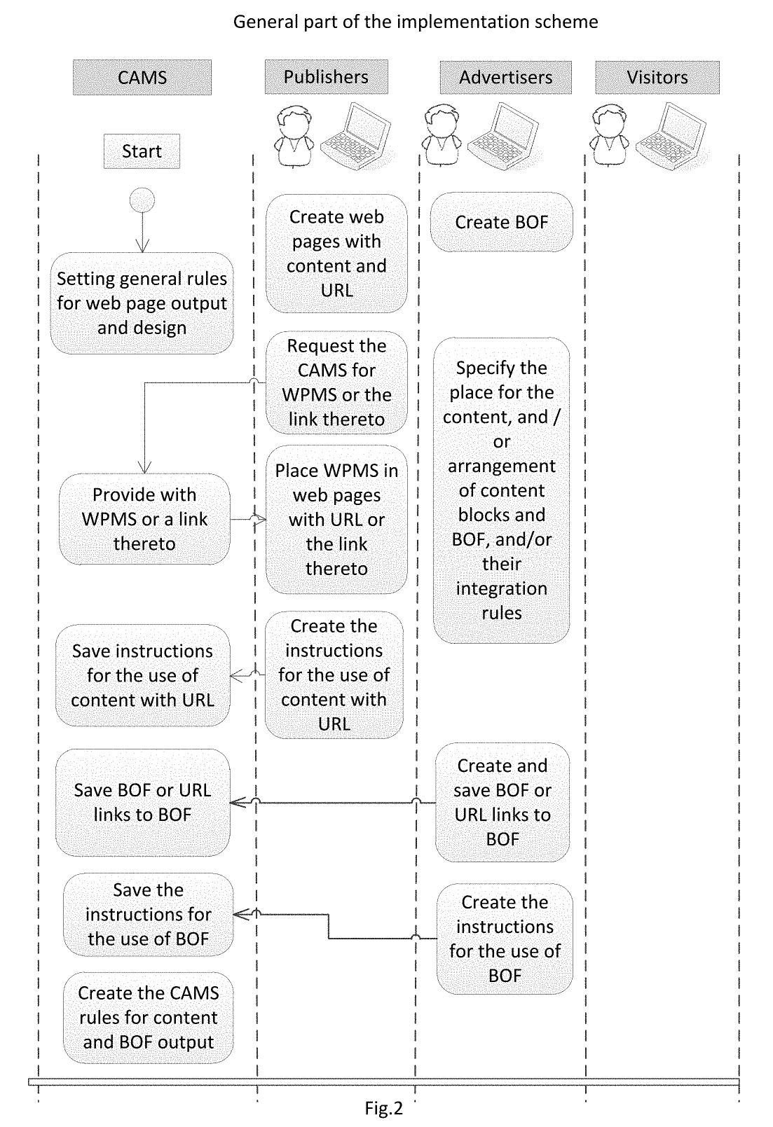

FIG. 3 shows the implementation scheme (algorithm) for the claimed method according to case 1,

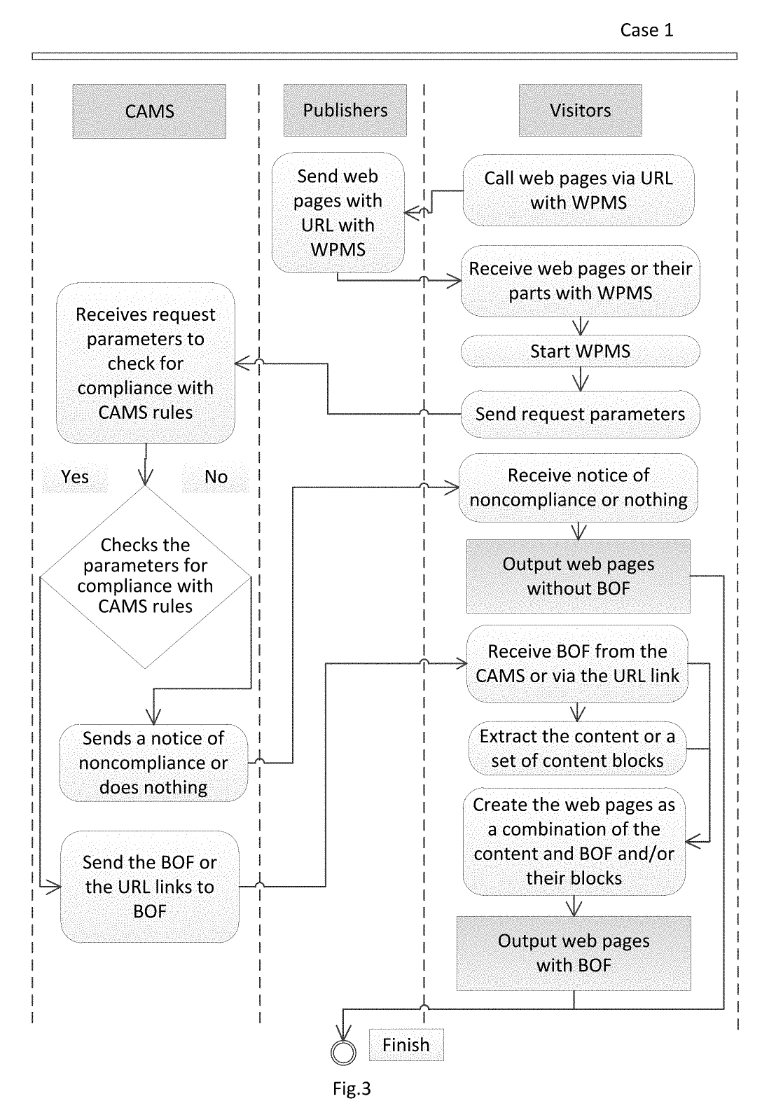

FIG. 4 shows the implementation scheme (algorithm) for the claimed method according to case 2;

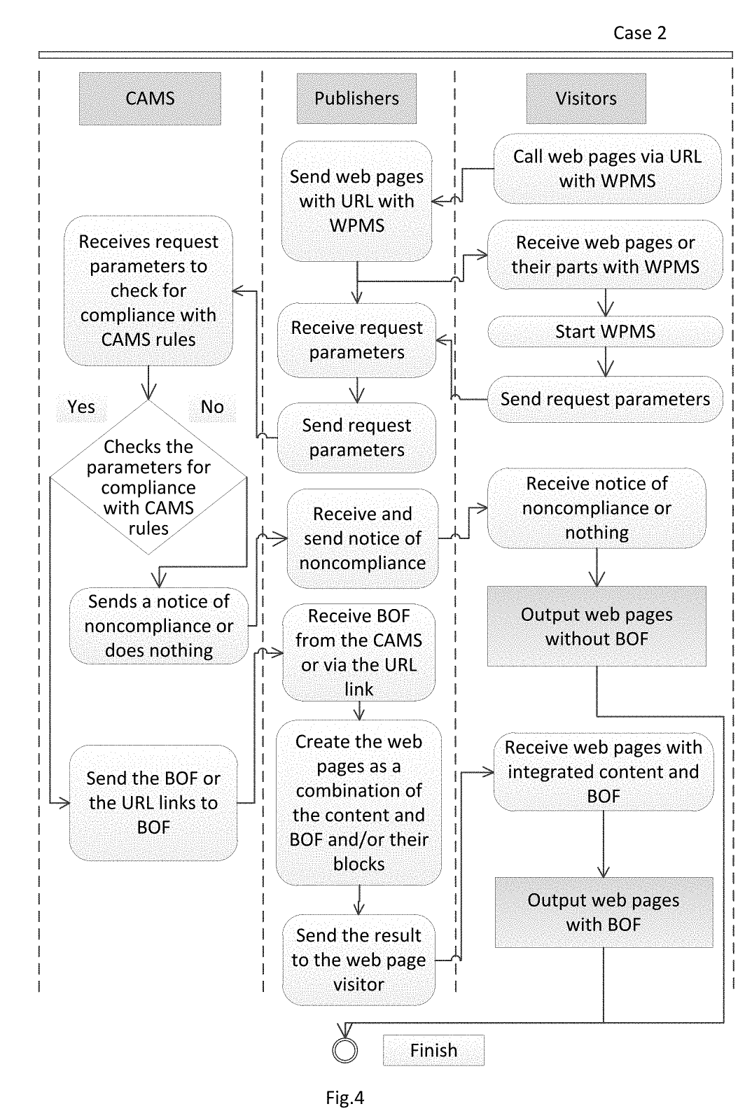

FIG. 5 shows the implementation scheme (algorithm) for the claimed method according to case

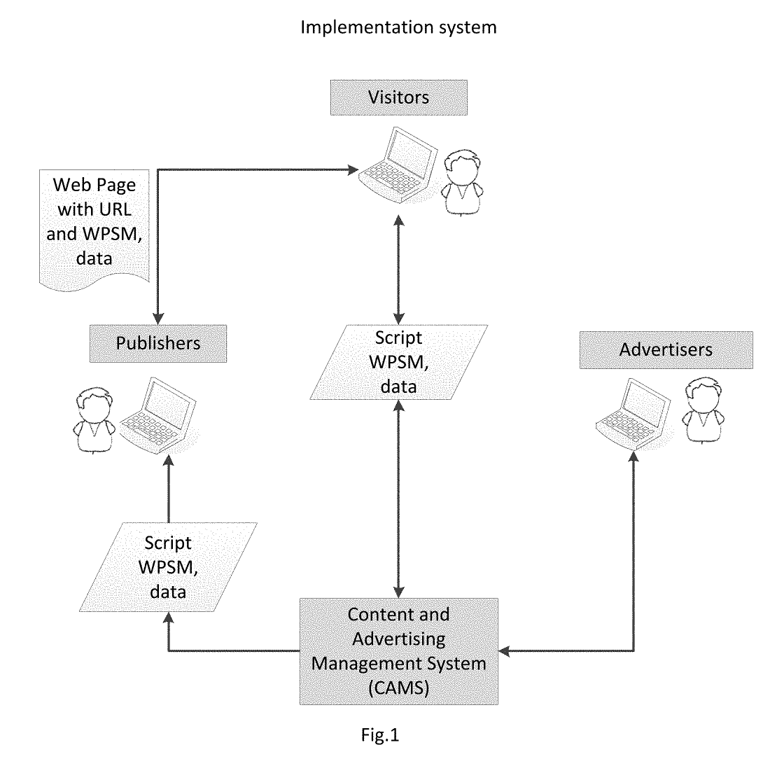

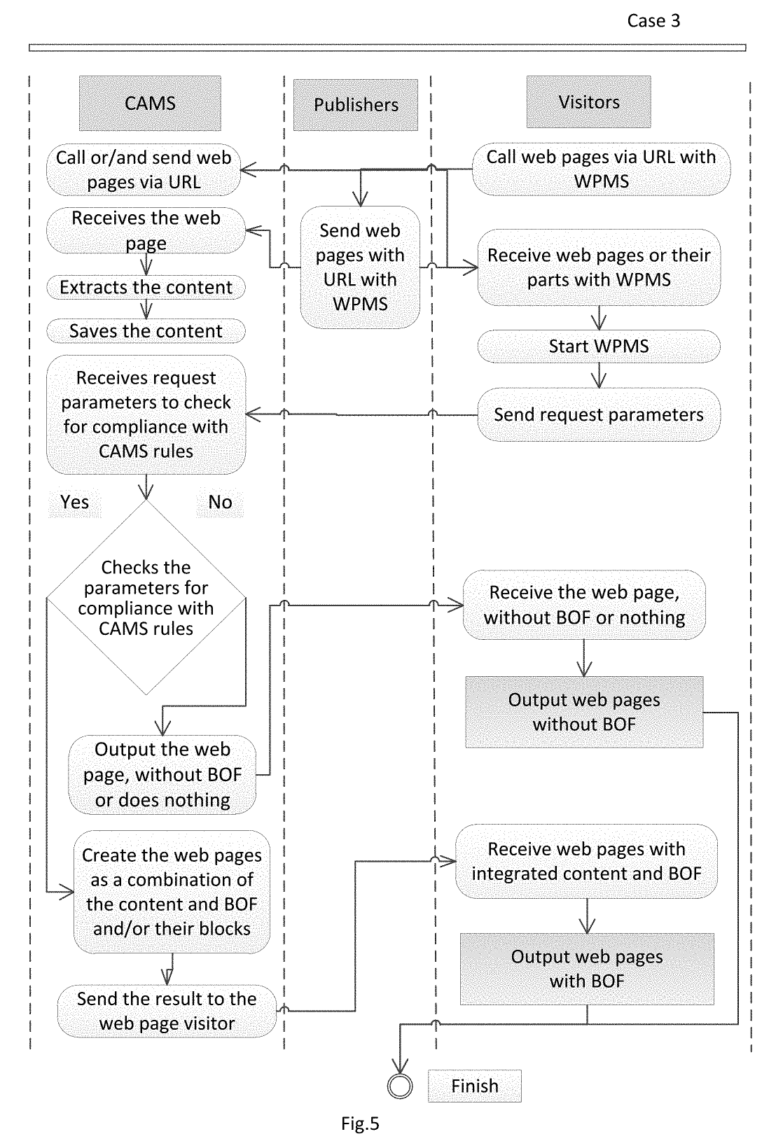

The system shown in FIG. 1 includes one or more computer devices, on which the CAMS and the data base are installed as well as visitors, as a minimum, and CAMS users: publishers, advertisers.

In all the cases of the method, publishers place their content in their individual CMS's or applications located on a hosting of their choice. As a result, web pages are created with individual URL's and with or without a certain design. These pages become available to an unlimited range of the visitors and, in particular, to search engines for indexing purposes. Then the publishers register in the CAMS, are assigned accounts, log into the CAMS, and become capable of interacting with advertisers. To this end, the publishers receive a web page management script (WPMS), place this script in the publishers' web page (-s) and input instructions into the CAMS with regard to the use of content.

According to one of the cases, instructions of one of the publisher may include permission to output ads from advertisers in all the regions except Moscow Region. In regards to Moscow Region, the instructions stipulate that the original design of the web page should be output.

In response to actions of the publisher, the CAMS saves current status of publisher related records in the data base. In particular, the CAMS saves the WPMS activity sign for the publishers' URL's, instructions for the content with the URL's, etc.

Advertisers register in the CAMS, are assigned accounts and log into the CAMS, and become capable of interacting with publishers. Advertisers create blocks of feedback (further—BOF's) for visitors in the form of brand banners, templates with banners or any other blocks for desired actions of the visitors. Advertisers specify the place for inserting the content within the BOF and save the BOF in the CAMS. To facilitate creation of BOF's, advertisers may, but are not obliged to, use a special editor in their personal CAMS account, which offers functions of downloading, coping and pasting, editing, formatting, data saving, etc. According to one of the cases, advertisers use a typical web page design, where the place for inserting content is specified. Web page formation is automated by means of a web page management script—WPMS. An advertiser, for example, inputs into the CAMS the instructions that its ads should be displayed in Smolensk Region.

In response to the actions of the advertiser, the CAMS saves current status of advertiser related records in the data base. In particular, the CAMS saves the activity sign of the advertisers' BOF's, completed program code of the BOF's or URL links to the BOF's, output instructions for the BOF's.

Based on the general rules of web page output, instructions of the publisher and the advertiser, the CAMS creates the rules for outputting the content and BOF: in Smolensk Region, the publisher's web page should be output with the advertiser's BOF as content combined with BOF. In Moscow Region, the original design of the web page should be displayed.

Visitors obtain access to the page with the publisher's content by means of URL. They can do it directly, or use search engines, shortcuts, hyperlinks, etc.

In response to that action, the publisher's CMS sends the web page to visitors, and the visitors receive that page. While, or after receiving the web page, the WPMS starts at the visitors' sides. This script determines request parameters (region, time of the request, screen resolution, type of device, key word (-s), demographic or behavioral parameters, etc.). As a result, the WPMS sends these parameters to the CAMS.

The CAMS receives the request parameters and checks them for compliance with the web page output rules. If the parameters do not comply with the CAMS rules, the visitors are instructed to output the web pages the way they have been downloaded via URL's, without BOF's, and the web pages are displayed in the visitors' screens.

If the parameters comply with the CAMS rules, the CAMS sends the BOF's to the visitors, or an URL links to the BOF's. The visitors receive the BOF's. The WPMS at the visitor's side extracts the content from the web page, creates a web page and output it as content and BOF. The content is inserted according to the place (-s) specified for that purpose by the advertiser, or according to the integration method specified by the advertiser. After that, web page is displayed in the visitors' screens.

In the example shown, visitors coming from a region, that has been identified as Smolensk Region, will display the advertiser's BOF with the publisher's content on their screens. Visitors from Moscow Region will display the original publisher's design of the web page on their screens.

Therefore, in the example shown, the proposed method expands possible applications of the online advertising by means of:
a source code of the advertiser's web page indicating the places for inserting the content can be used as the advertiser's BOF, which makes it easier for the advertiser to create advertising materials;
the publisher adds one WPMS code to any one place of the publisher's web page. It is not required to change the markup of the publisher's web page, nor it is necessary to add more than one script from several ad providers that can be in the case of usual banners;
extracting of the content, combining it with the BOF template and outputting take place at the visitor's side. Therefore, the CMS's of the publishers and of the advertisers need no upgrading or modifying, except the currently well-established operation of inserting the WPMS into the publisher's web page.
in the claimed method, both advertisers and publishers have equal rights to save direct instructions (not only depending on the ratings) with regard to outputting the advertising with content and the content with advertising, respectively. This creates a basis for complex auction models for joint outputting of the content and advertising. The range of parties involved in such

The invention claimed is:

1. The online method of creating advertising web pages and their content management, including the use of the Content and Advertising Management System—CAMS, involvement of visitors and such users as advertisers that use CAMS for outputting blocks of feedback—BOF's within the general rules for web pages output and design, having the following features:
the method includes the use of CAMS and the involvement of such users as publishers, and
the CAMS sets forth the general rules for web pages output and design, provides publishers with a web page management script—WPMS or a link thereto, saves instructions for the use of content with URL's, saves BOF's or URL links to BOF's and sends the BOF's or URL links to the BOF's to visitors, saves instructions for using the BOF's, creates CAMS rules for content and BOF's output based on publishers' and advertisers' instructions, receives request parameters to check for compliance with the CAMS rules, checks the parameters for compliance with the CAMS rules; if the parameters do not comply with the CAMS rules, CAMS sends a notice of noncompliance or does nothing, and if the parameters comply with the CAMS rules, CAMS sends the BOF's or URL links thereto to visitors,
publishers create web pages in the content management systems (CMS's) with content and URL's, request the CAMS for WPMS or the link thereto, place WPMS in the web pages with URL's or the link thereto, create the instructions for the use of content with URL's and save them in the CAMS, send web pages with WPMS and URL's to visitors via the Internet,
advertisers create BOF's for visitors, specify the place for the content, or/and arrangement of content blocks and BOF's, or/and their integration rules, save BOF's or URL links to BOF's in the CAMS, create the instructions for the use of BOF's and save them in the CAMS,
visitors of the publishers' web pages call web pages with WPMS via URL's, receive web pages or their parts with WPMS, start WPMS and send request parameters to the CAMS, and if the parameters do not comply with the CAMS rules, visitors output the web pages the way they received them via URL's without BOF's, and if the parameters comply with the CAMS rules, visitors of web pages with URL's receive BOF's from the CAMS or via the URL links sent from the CAMS, use the WPMS to extract the content or a set of content blocks from the received web pages, create the web pages as a combination of the content and BOF's or/and their blocks, and output web pages for displaying or/and processing them in other ways.

2. The online method of creating advertising web pages and their content management, including the use of the Content and Advertising Management System—CAMS, involvement of visitors and such users as advertisers that use CAMS for outputting blocks of feedback—BOF's within the general rules for web pages output and design, having the following features:
the method includes the use of CAMS and the involvement of such users as publishers, and
the CAMS sets forth the general rules for web pages output and design, provides publishers with a web page management script—WPMS or a link thereto, saves instructions for the use of content with URL's, saves BOF's or URL links to BOF's and sends the BOF's or URL links to the BOF's, saves instructions for using the BOF's, creates CAMS rules for content and BOF's output based on publishers' and advertisers' instructions, receives request parameters to check for compliance with the CAMS rules, checks the parameters for compliance with the CAMS rules; if the parameters do not comply with the CAMS rules, CAMS sends a notice of noncompliance, or does nothing, and if the parameters comply with the CAMS rules, CAMS sends the BOF's or URL links thereto to publishers',
publishers create web pages in the content management systems (CMS's) with content and URL's, request the CAMS for WPMS or the link thereto, place WPMS in the web pages with URL's or the link thereto, create the instructions for the use of content with URL's and save them in the CAMS, send web pages with WPMS and URL's to visitors via the Internet, receive request parameters, send these parameters to the CAMS; if the parameters do not comply with the CAMS rules, output the web pages with URL's without BOF's, and if the parameters comply with the CAMS rules, receive BOF's from the CAMS or via the URL links sent from the CAMS, create the web pages as a combination of the content and BOF's or/and their blocks, and send the result to the visitors,
advertisers create BOF's for visitors, specify the place for the content, or/and arrangement of content blocks and BOF's, or/and their integration rules, save BOF's or URL links to BOF's in the CAMS, create the instructions for the use of BOF's and save them in the CAMS,
visitors of the publishers' web pages call web pages with WPMS via URL's, receive web pages or their parts with WPMS, start WPMS and send request parameters to the publishers or/and CAMS, and if the parameters do not comply with CAMS rules, visitors output the web pages the way they received them via URL's without BOF's, and if the parameters comply with CAMS rules, visitors of web pages with URL's receive web pages with integrated content and BOF's or/and their blocks, and output web pages for displaying or/and processing them in other ways.

3. The online method of creating advertising web pages and their content management, including the use of the Content and Advertising Management System—CAMS, involvement of visitors and such users as advertisers that use CAMS for outputting blocks of feedback—BOF's within the general rules for web pages output and design, having the following features:
the method includes the use of the CAMS, involvement of such users as publishers, and
the CAMS sets forth the general rules for web pages output and design, provides publishers with a web page management script—WPMS or a link thereto, saves instructions for the use of content with URL's, saves BOF's or URL links to BOF's and sends the BOF's or URL links to the BOF's, saves instructions for using the BOF's, creates CAMS rules for content and BOF's output based on publishers' and advertisers' instructions; calls publisher's pages with URL's via the Internet, receives the publishers' web pages, extracts and saves the content or a set of content blocks from the received publishers' web pages; receives request parameters to check for compliance with CAMS rules, checks the parameters for compliance with the CAMS rules; if the parameters do not comply with the CAMS rules, CAMS sends a notice of noncompliance, or does nothing; and if the parameters comply with the CAMS rules, CAMS create a web pages as a combination of the content and BOF's or/and their blocks, and sends the result to the visitors,
publishers create web pages in the content management systems (CMS's) with content and URL's, request the CAMS for WPMS or the link thereto, place WPMS in the web pages with URL's or the link thereto, create the instructions for the use of content with URL's and save them in the CAMS, send web pages with WPMS and URL's to visitors via the Internet,
advertisers create BOF's for visitors, specify the place for the content, or/and arrangement of content blocks and BOF's, or/and their integration rules, save BOF's or URL links to BOF's in the CAMS, create the instructions for the use of BOF's and save them in the CAMS,
visitors of the publishers' web pages call web pages with WPMS via URL's, receive web pages or their parts with WPMS, start WPMS and send request parameters to the CAMS, and if the parameters do not comply with CAMS rules, visitors output the web pages the way they received them via URL's without BOF's, and if the parameters comply with CAMS rules, visitors of web pages with URL's receive web pages with integrated content and BOF's or/and their blocks, and output web pages for displaying or/and processing them in other ways.
